(19) United States
(12) Patent Application Publication
(10) Pub. No.: US 2003/0024552 A1
(43) Pub. Date: Feb. 6, 2003

(54) Air conditioner cleaning device and method for cleaning an air conditioner

(75) Inventor: Yasuo Watanabe, Tokyo (JP)

Correspondence Address: ARMSTRONG,WESTERMAN & HATTORI, LLP, 1725 K STREET, NW., SUITE 1000, WASHINGTON, DC, 20006, US

(73) Assignee: M.T. SYSTEM CO., LTD., Tokyo (JP)

(21) Appl. No.: 10/263,728

(22) Filed: Oct. 4, 2002

Related U.S. Application Data
(63) Continuation-in-part of application No. 09/595,907, filed on Jun. 20, 2000.

(30) Foreign Application Priority Data
Mar. 29, 2000 (JP) 90396/2000

(51) Int. Cl. B08B 3/04; B08B 7/04; B08B 3/00; B08B 7/00

(52) U.S. Cl. 134/26; 134/30; 134/34; 134/37; 134/19; 134/94.1; 134/102.1; 134/104.2

(57) ABSTRACT

An air conditioner cleaning device with which the use of detergent can be decreased to zero or minimized and washing time can be shortened. A feature is that the device comprises a watertight cover to receive washings for the air conditioner that is set in the ceiling, the nozzles—located above the watertight cover—for washing an air conditioner from which steam, warm water, and air for drying gush out, and a steam generator that connects to the steam supply line of the nozzles so that the steam generated with the steam generator and warm water shall be below the specified temperature and gush out from said nozzles.

CROSS REFERENCE TO RELATED APPLICATIONS

This application is a continuation-in-part of prior application Ser. No. 09/595,907 filed Jun. 20, 2000.

### BACKGROUND OF THE INVENTION

This invention is concerned with an air conditioner cleaning device and cleaning method that are used to clean the air conditioner installed in the ceiling. With this invention, the use of detergent and wash water can be remarkably decreased and work hours can be shortened.

Heretofore, to recover thermal efficiency and not to pollute room air, air conditioners embedded in the ceiling have been automatically cleansed and dirt such as dust lampblack attached to the coil fins of the air conditioners has been removed as well.

Before, detergent has been used generally to clean air conditioners installed in the ceiling because contamination with oil cannot be removed easily only with water. Also, automatic cleaning machines were used before, with which detergent and high pressure water were blown to remove dirt.

As a defect, the use of detergent, however, may have caused environmental pollution at any time. Because a neutralization agent and a lot of rinse water were required to process the detergent, expenses increased and a lot of waste water was resulted.

Since the method using an automatic cleaning machine needs a high pressure, the area had to be washed little by little. Thus, it took a long time for washing which is a disadvantage.

Moreover, the conventional method as explained above requires a lot of water supply and drainage. Precision instrument factories, research laboratories, and offices were in danger of a secondary pollution accompanied by washing. The equipment was too large and a hose had to be dragged when blowing water. Thus, it was not so easy to use this equipment.

### SUMMARY OF THE INVENTION

It is an object of this invention to provide an easy-to-use air conditioner cleaning device and cleaning method with which detergent can be minimized or lessened to zero and washing time can be shortened.

For the above object, this invention includes a watertight cover with which wash liquid for washing the air conditioner installed in the ceiling can be received; a nozzle located above the watertight cover from which steam, warm water, and dried air can gush out; and a steam generator that is connected to the steam supply line of the nozzle. The steam generated in the steam generator and warm water, which are set below the specified temperature, gush out from above mentioned nozzle.

A method for cleaning an air conditioner set in a ceiling comprising: covering a lower portion of the air conditioner to be cleaned with a watertight cover to receive washings; ejecting steam at a temperature of 70-90° C. from a cleaning nozzle positioned within the watertight cover so as to contact said air conditioner; ejecting water at a temperature of 40-70° C. from said nozzle; and ejecting drying air from said nozzle.

In short, with the inventions, the use of detergent can be minimized or lessened to zero by gushing out warm water to wash away dirt after dirt is floated with steam. Then by drying with air after washing, time required for finishing can be remarkably shortened.

The above and other objects and advantages of the invention will become more apparent from the following description.

### BRIEF DESCRIPTION OF THE DRAWINGS

FIG. 1 is a perspective view of an embodiment of this invention;

FIG. 2 is a perspective view indicating a nozzle of this invention;

FIG. 3 is a schematic drawing indicating a steam generator of this invention;

FIG. 4 is a perspective view indicating a other embodiment of this invention;

FIG. 5 is a perspective view of other nozzle that is used to replace the nozzle of the device of this invention; and

FIG. 6 is a perspective view of the device of this invention when other nozzle is mounted.

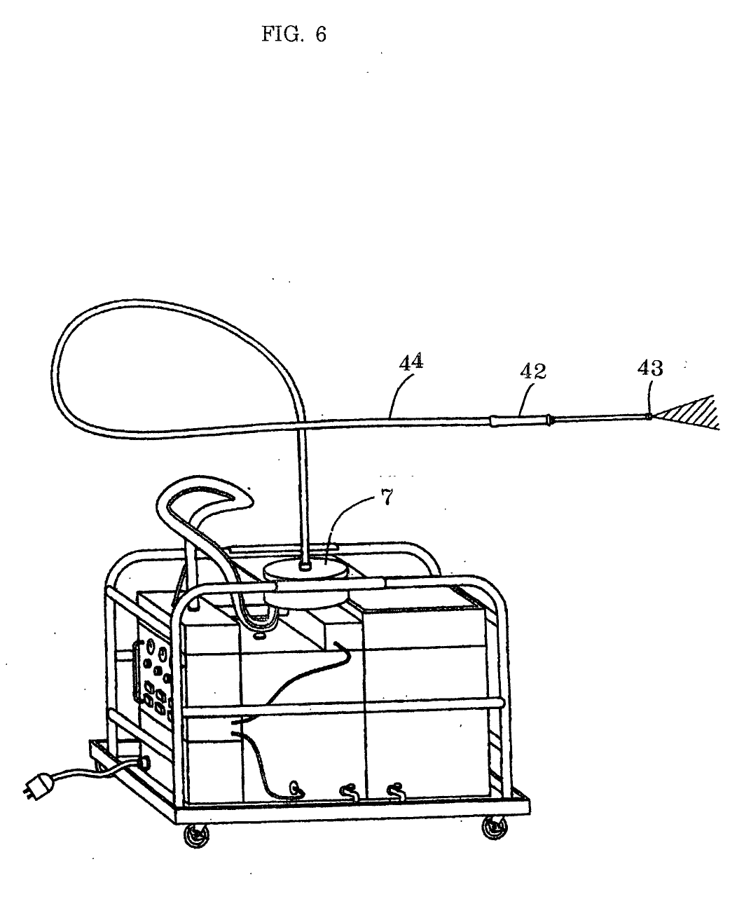

### DETAILED DESCRIPTION OF THE PREFERRED EMBODIMENT

The embodiment of this invention is explained according to the drawings as follows:

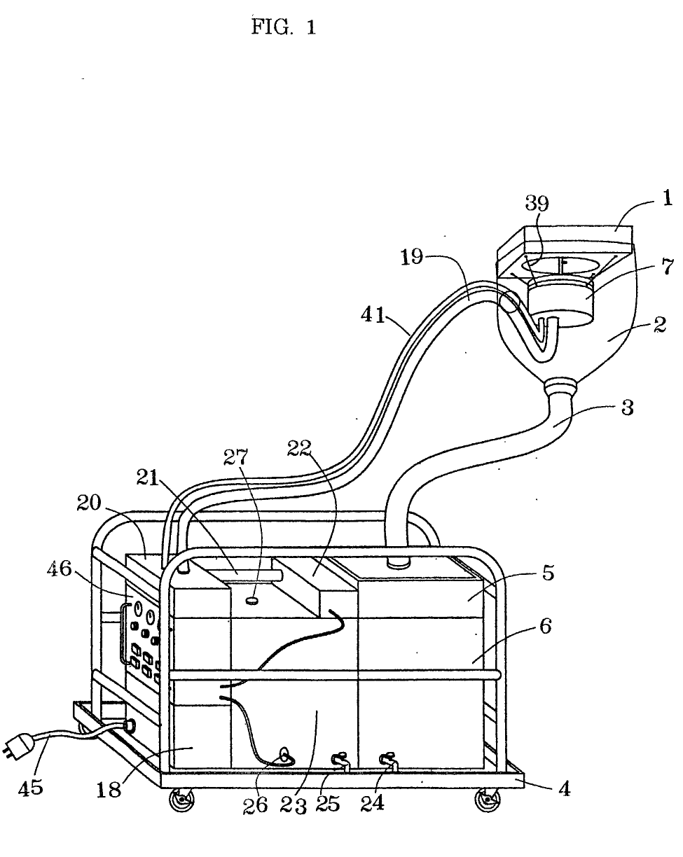

FIG. 1 shows an embodiment of this invention. The upper opening of watertight cover 2 is fitted to air conditioner 1 (this is to be washed) that is mounted in the ceiling. Waste water hose 3 that is connected to the bottom of watertight cover 2 is connected to waste water tank 6 via waste water filter 5 which is placed on carriage 4.

After washing the air conditioner, wash liquid is kept temporarily in watertight cover 2. It passes through waste water hose 3 and is filtered with waste water filter 5. Waste water is finally kept in waste water tank 6.

Note that 24 indicated in the figure is the drain cock of the waste water tank.

Within waterproof cover 2, head 7 of the cleaning device is fixed to air conditioner 1 with wire 39. Watertight cover 2 covers the whole portion that is to be washed so that washings, dust, dirt, and bacteria do not leak out.

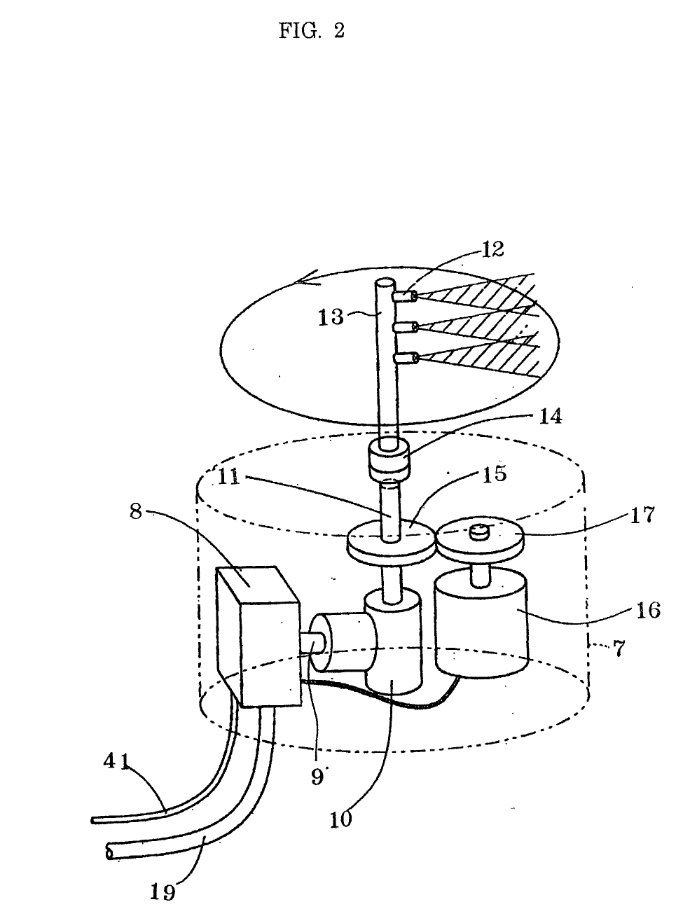

As shown in FIG. 2, head portion 7 contains steam generator 8, steam supply pipe 9 that is connected to steam generator 8, and nozzle rotary shaft 11 that is connected vertically to steam supply pipe 9 via rotary joint 10. The top of pipe 13 is closed and nozzles 12 are attached to pipe 13. Nozzle shaft 11 can be connected to or removed from pipe 13 with coupler 14.

Three nozzles 12 are mounted in pipe 13 vertically at intervals. Since this multi-nozzle pipe can cover the whole part of the coil fin from up to down at a time and rotation is only necessary motion, the mechanism is simplified.

Gear 15 is fixed to rotary shaft 11 and this gear 15 is engaged with gear 17 that rotates with motor 16. Gear 15 can rotate forward and reverse.

Air and warm water hose 19 is connected to the bottom of steam generator 8. This hose 19 is connected to air/warm selector 20 which is above air compressor 18 that is mounted on carriage 4. Note that numeral 45 in FIG. 1 indicates a power cord while 46 is the operation panel.

Air/warm water selector 20 is connected to warm water tank 23 via water pipe 21 and feed-water pump 22. Numeral 25 in FIG. 1 indicates a warm water tank drain and Numeral 26 indicates a heater for warm water. Water is poured into warm water tank 23 from water supply hole 27.

Therefore, feeding air to air/warm water hose 19 from air compressor 18 or feeding warm water to air/warm water hose 19 from warm water tank 23 can be selected with air/warm water selector 20. Air/warm water selector 20 allows switching to air or warm water with a solenoid valve.

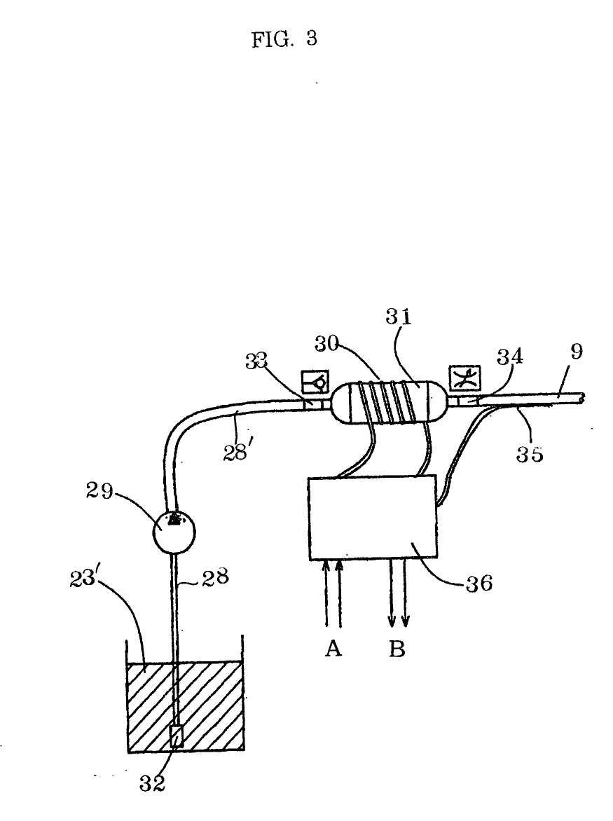

FIG. 3 shows an embodiment of steam generator 8. It has tank 23′ in which hot water or water is contained, pump 29 for pumping up hot water or water via pipe 28, chamber 31 in which pumped up hot water or water is heated into steam with heater 30, and steam supply line 9 through which steam made within chamber 31 is fed to nozzle 12. Note that filter 32 for removing dirt is attached to the lower end of pipe 28.

Non-return valve 33 is set to pipe 28′ that is near entrance of chamber 31 and pressure control valve 34 is set to steam supply line 9 that is the exit of chamber 31 so that pressure within chamber 31 can be increased to the specified level.

In the above example, heater 30, chamber 31, pressure control valve 34. Non-return valve 33 are built in one. This structure can make a steam generator compact.

Although washing efficiency is better in general when the temperature of steam or hot water is high, it is necessary to keep the temperature of the coil fin and the refrigerant pipe, which is contained within the coil fin, less than 100° C. The coil fin and the refrigerant pipe should be kept less than 90° C. and preferably less than 80° C., though there are differences depending on the materials and method of manufacture.

To make both washing efficiency and above temperature range available, the sensor and temperature adjustment feature are provided so that the temperature of steam at the nozzle exit can be adjusted to the range between 70° C. and 90° C. and preferably 75° C. and 85° C. and the temperature of hot water between 40° C. and 70° C. and preferably 50° C. and 65° C.

Damage on the coil fin and the portion near the coil fin can be avoided by controlling temperature while maintaining high washing efficiency with steam or hot water.

In the above example, steam temperature is measured with sensor 35 that is fixed to steam supply line 9 and temperature control device 36 controls the temperature of heating in order to control the temperature of steam.

With temperature information B measured with sensor 35, power source A is controlled, and by controlling the heat of heater 30, the temperature of steam to be fed nozzle 12 is controlled.

Temperature may be adjusted by using fresh air to cool the pipe through which the steam generated with the high pressure steam generator is fed into the nozzles or by entering fresh air into the pipe to cool. The temperature of the steam that gushes out from the nozzles can be kept at a specified range by adjusting the quantity of intake fresh air according to the temperature measured near the nozzles.

In the above example, warm water coming from warm water tank 23 passes through channel 31. This is convenient because warm water coming from warm tank 23 can be changed into steam, though it is not always necessary to do so. Note that since the air coming from compressor 18 may not be heated in particular, it goes to steam supply line 9 not via chamber 31 but via by pass (omitted in figure) and gushes out from nozzle 12.

In the examples shown in above FIGS. 1 and 2, air/warm water hose 19 shown in FIG. 1 and pipes 28 and 28′ shown in FIG. 3 are configured to be the same. Although this is not always necessary, it is desirable because the device can be compact.

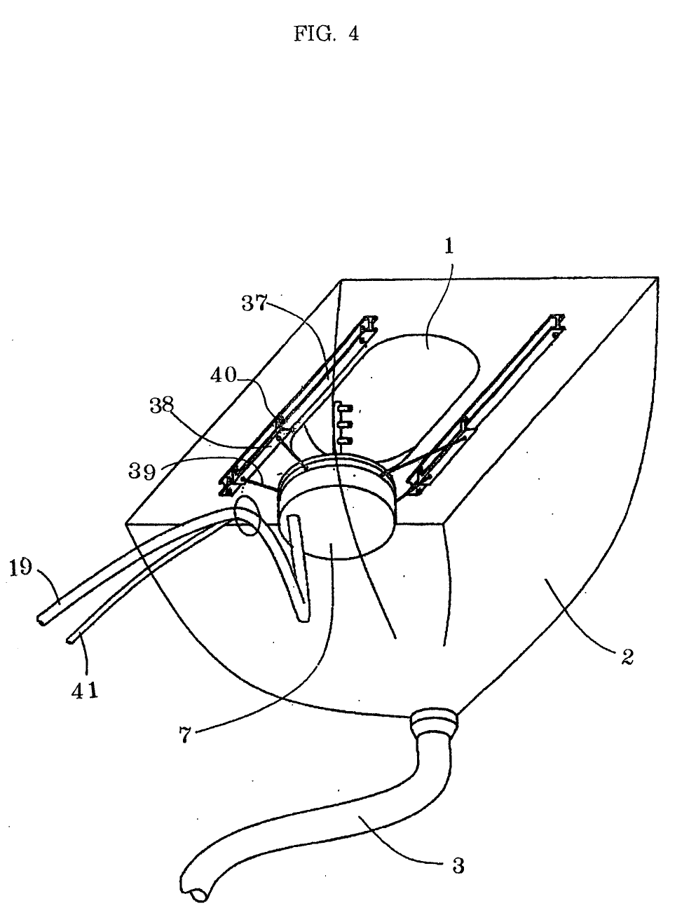

FIG. 4 shows another embodiment of this invention when a rectangular air conditioner is used.

While fixing cross section H-type rail 37 to both sides of the opening of air conditioner 1 that is set in the ceiling and connecting head 7 to slide member 38 that holds rail 37 by using wire 39, head 7 can slide along the concaved portion of rail 37 with roller 40 (that is set to slide member 38) n the alongside direction of air conditioner 1 to clean the air conditioner.

Note that 41 in FIG. 1 indicates power, control cable and supplies power to nozzles 12 for rotation and the steam generator.

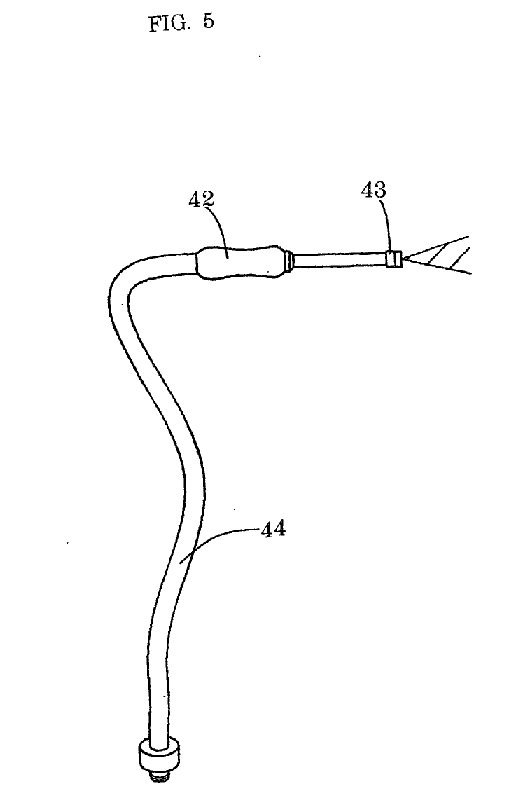

After pipe 13 in FIG. 2 is removed by rotating coupler 14, the nozzle as shown in FIG. 5 can be mounted. Holding grip 42 that is fixed to heat-resistant hose 44 allows direct nozzle 43 to be directed at the target to be washed.

Hereafter explains how to use the device of this invention of the above configuration.

First, set the device of the invention directly below air conditioner 1 in the ceiling as shown in FIG. 1. If the air conditioner is extremely dirty, spray the coil fin of air conditioner 1 with a little neutral detergent of foam type. It is desirable to use neutral detergent of a foam type because it needs only a little.

Then, communicate air/warm water selector 20 with warm water line, and pump up warm water from warm water tank 23 with warm water pump 22. Then, feed it into steam generator 8 through hose 19.

The pressure of the steam generated in steam generator 8 is adjusted so that the temperature of steam is approximately 80° C. at the exit of nozzles 12, and this steam gushes out from this rotating nozzles 12. By rotating the pipe in which many nozzles are mounted, a large area can be washed at a time and washing time can be shortened.

Then, after a specified time, steam can be stopped and warm water of approximately 60° C. is gushed out from rotating nozzles 12 via steam generator 8. The quantity of warm water supply will be greater by several score times or several hundred times compared with that of steam.

Waste water after washing goes through waste water hose 3 and enters into waste water filter 5 that is set on carriage 4. It is kept in waste water tank 6 after removing dirt roughly.

After a specified time, supply of warm water stops. Air is released in the washing side and warm water included within supply hose returns to water tank 23 as the valve is switched to steam condensate line side with feed-water pump side.

By washing with steam as explained with this invention, dirt becomes floated. Only a little water is necessary to do so. Then, dirt can be peeled off easily by jetting warm water at the dirt and a high water pressure is unnecessary. Waste water decreases since washings decrease to approximately 20 to 30% compared with the quantity of washings required for conventional methods.

When warm water is removed from the feeding hose, the air passage connecting from compressor 18 connects to the passage of hose 19 by using air/warm water selector 20. Then, dried air (high pressure air) is supplied from compressor 18 via the drain to the washing portion. High pressure air of 5 to 7 atmospheric pressure gushes out from the nozzles 12. By blowing dried air after washing, the target dries quickly and time of final finishing can be shortened.

Although dried air may be heated up to approximately 80° C., room temperature is good enough. Room temperature is more desirable in the light of compactization of the device. Concerning pressure, 5 to 10 atmospheric pressure had better be used.

Above example is when hose 19 is used commonly for warm water and air up to immediately before chamber 31. When different hoses are used, air can blow before water is completely removed.

Control panel 46 controls operations automatically until immediately before the device of this invention is removed from the air conditioner after the start switch is pressed and the washing and drying processes have finished.

Using the device of this invention, the use of neutral detergent, steam, and warm water can be minimized. Environmental impact can be minimized as well.

As the use of water can be decreased with the device of this invention, the whole device can be compact. As the device is compact, it is unnecessary to move the positions of equipment and furnishings in precision machining factories, institutions, and offices and influence on user's job can be minimized when washing an air conditioner.

By using steam and drying with air, working hours can be remarkably decreased compared with conventional methods.

As described above, the use of detergent can be reduced to zero or minimized and washing time can be shortened. At the same time, the device of this invention can be used for precision machining factories, institutions, and offices to which the devices of other types could not be applied easily before. The effect of this device is greater than any other types that were available before.

What is claimed is:

1. The air conditioner cleaning device, comprising a watertight cover to receive washings for the air conditioner that is set in the ceiling, air conditioner cleaning nozzles that locate above the watertight cover, from which steam, warm water and air for drying gush out, and steam generator from which the steam supply line of the nozzles is connected, steam that is generated with the steam generator and warm water is adjusted to less than specified temperatures and it gushes out from the nozzles mentioned above.

2. The device according to claim 1, wherein a rotating pipe whose top is closed and in which said multiple cleaning nozzles are formed vertically.

3. The device according to claim 2, wherein the means to rotate the pipe and said steam generator are contained in the container to form the head portion and this head portion is included within said watertight cover.

4. The device according to claim 3, wherein opening in the lower end of said watertight cover is connected with a waste water hose and, through this hose, waste water enters the waste water tank via the waste water filter.

5. The device according to claim 1, wherein said steam generator includes a chamber for heating pumped up warm water or water with a heater to evaporate it, a steam supply pipe for feeding the evaporated steam to the nozzles, a non-return valve that is set in the pipe of near the entrance to the chamber, and a pressure control valve that is set to the steam supply pipe at the exit of the chamber.

6. The device according to claim 5, wherein it is configured so that warm water is poured into said chamber via the hose connected to the chamber and the air or warm water path in this hose communicates with the air compressor or warm water tank via the air/warm water selector.

7. The device according to claim 5, wherein temperature is measured with the sensor that is connected to said steam supply pipe and said heater is controlled to heat the said chamber according to the result of this measurement in order to adjust the temperature of steam and warm water that gush out from said nozzles.

8. The device according to claim 1, wherein it is configured so that said head portion can slide in the direction of the length of said air conditioner.

9. A method for cleaning an air conditioner set in a ceiling comprising:
covering a lower portion of the air conditioner to be cleaned with a watertight cover to receive washings;
ejecting steam at a temperature of 70-90° C. from a cleaning nozzle positioned within the watertight cover so as to contact said air conditioner;
ejecting water at a temperature of 40-70° C. from said nozzle; and
ejecting drying air from said nozzle.

10. The method according to claim 9, further including rotating said cleaning nozzle, said cleaning nozzle being formed vertically in rotating pipe whose top is closed.

11. The method according to claim 10, wherein said steam is generated in a steam generator, said steam generator and means to rotate the rotating pipe being contained in a container so as to form a head portion, this head portion being included within said watertight cover.

12. The method according to claim 9, further including allowing waste water collected in said watertight cover to flow through an opening in a lower end of said watertight cover through a waste water hose with a waste water filter and into a waste water tank.

13. The method according to claim 11, wherein said steam is generated in said steam generator by pumping pumped up warm water or water into a chamber of said steam generator and heating said water with a heater in the chamber so as to evaporate the water, and said steam is fed to the nozzle by a steam supply pipe having a non-return valve near the entrance to the chamber and a pressure control valve supply pipe at the exit of the chamber.

14. The method according to claim 13, further including pouring water into said chamber via a hose connected to the chamber, said hose having an air or warm water path communicating with an air compressor or warm water tank via an air/warm water selector.

15. The method according to claim 13, wherein a temperature sensor is connected to said steam supply pipe for measuring steam temperature and is connected to control device for controlling said heater to heat the said chamber according to the steam temperature measured by the temperature sensor in order to adjust the temperature of steam and warm water that are ejected from said nozzle.

16. The method according to claim 11, further including sliding said head portion in the direction of the length of said air conditioner.
